(19) United States
(12) Patent Application Publication
(10) Pub. No.: US 2021/0060642 A1
(43) Pub. Date: Mar. 4, 2021

(54) SILICON OXIDE-COATED SOFT MAGNETIC POWDER AND METHOD FOR PRODUCING SAME

(71) Applicant: DOWA ELECTRONICS MATERIALS CO., LTD., Tokyo (JP)

(72) Inventors: Koji TANOUE, Tokyo (JP); Takuya YANO, Tokyo (JP); Yorito NISHIZAWA, Tokyo (JP)

(21) Appl. No.: 16/963,602

(22) PCT Filed: Feb. 15, 2019
(86) PCT No.: PCT/JP2019/005474

§ 371 Date: Jul. 21, 2020

(30) Foreign Application Priority Data
Feb. 20, 2018 (JP) 2018-027545

(51) Int. Cl. B22F 1/02; H01F 1/147; C22C 19/03; B22F 1/00

(52) U.S. Cl. CPC B22F 1/02; H01F 1/147; C22C 19/03; B22F 2304/10; C22C 2202/02; B22F 2301/15; B22F 2302/256; B22F 1/0011

(57) ABSTRACT

A silicon oxide-coated soft magnetic powder has excellent insulating property and provides a high powder compact density. In making the powder, silicon alkoxide is added to a slurry containing soft magnetic powder containing iron in an amount of 20% by mass or more dispersed in a mixed solvent of water and an organic solvent containing water in an amount of 1% by mass or more and 40% by mass or less. A hydrolysis catalyst for the silicon alkoxide is then added to perform silicon oxide coating. The coated magnetic powder has a coverage factor R of 70% or more defined by R=Si×100/(Si+M) (wherein Si and M represent molar fractions of Si and elements constituting the soft magnetic powder obtained by an XPS measurement), a powder compact density of 4.0 g/cm³ or more, and high μ′ at high frequency and high insulating property.

### TECHNICAL FIELD

The present invention relates to silicon oxide-coated soft magnetic powder that has a good insulating property and a high permeability (μ) and is suitable for the production of a powder compact magnetic core for an electric or electronic component, such as an inductor, a choke coil, a transformer, a reactor, and a motor, and a method for producing the same.

### BACKGROUND ART

A powder compact magnetic core using soft magnetic powder, such as iron powder, alloy powder containing iron, and intermetallic compound powder, has been known as a magnetic core for an inductor, a choke coil, a transformer, a reactor, a motor, and the like. However, the powder compact magnetic core using the soft magnetic powder containing iron has a lower electric resistivity than a powder compact magnetic core using ferrite, and therefore is produced by coating the surface of the soft magnetic powder with an insulating film, and then subjecting to compression molding and heat treatment.

Various materials have been proposed as the insulating film, and a silicon oxide coating has been known as a highly insulating coating. As the soft magnetic powder that is coated with a silicon oxide by a dry method, for example, PTL 1 describes Fe—Si—Cr—Ni alloy powder having a SiO₂ film having a thickness of from 5 to 10 nm formed with a vibration sputtering device. PTL 2 describes Fe—Si—Cr based magnetic metal powder coated with borosilicate alkali glass containing 79% by weight of SiO₂ by a mechanofusion method. As the soft magnetic powder that is coated with a silicon oxide by a wet method, for example, PTL 3 describes Fe-6.5% Si powder obtained by coating a hydrolyzate of tetraethoxysilane by using an IPA (isopropanol) solution of tetraethoxysilane, and then drying at 120° C. PTL 4 describes a technique of coating magnetic powder containing an Fe—Pd core as a hard magnetic material coated with Fe as a soft magnetic material, with a SiO₂ film having a thickness of from 1 to 13 nm by using tetraethyl orthosilicate (tetraethoxysilane).

### CITATION LIST

### Patent Literatures

PTL 1: WO 2007/013436

PTL 2: WO 2014/013896

PTL 3: JP-A-2009-231481

PTL 4: JP-A-2017-152609

### SUMMARY OF INVENTION

### Technical Problem

However, the sputtering method described in PTL 1 can form a thin film having an extremely small thickness on the surface of powder, but is difficult to form a uniform thin film, and therefore both the insulating property and the magnetic characteristics cannot be achieved simultaneously. The mechanofusion method described in PTL 2 has a problem that the resulting surface coating has a large amount of voids, which exposes a part of the surface of the soft magnetic powder, and thus the good insulating property cannot be secured.

The wet method is promising as an industrial production method of soft magnetic powder coated with an insulating material due to the excellent productivity thereof, but the insulating material-coated soft magnetic powder obtained in PTL 3 has a problem that the average thickness of the coating layer is large, which decreases the powder compact density of the magnetic powder, resulting in the deterioration of the magnetic characteristics. The technique described in PTL 4 has a problem that the insulating material-coated hard magnetic powder is produced through the reducing heat treatment, and the coated particles synthesized by this production method cause aggregation to decrease the powder compact density of the magnetic powder, resulting in the deterioration of the magnetic characteristics. Furthermore, the size of the powder compact magnetic core is increased for providing the prescribed magnetic characteristics, and thus the demand of reduction in size of products cannot be addressed.

Moreover, the technique described in PTL 4 has a problem that the process step of forming the insulating material coating shell on the surface of the core through the reducing heat treatment is required, which makes the process complicated.

In view of the aforementioned problems, an object of the present invention is to provide silicon oxide-coated soft magnetic powder that is excellent in insulating property and is capable of providing a high powder compact density, by coating a silicon oxide having good uniformity of the thickness with less defects on the surface of soft magnetic powder, and a method for producing the same.

### Solution to Problem

For achieving the object, the present invention provides silicon oxide-coated soft magnetic powder containing particles containing particles of soft magnetic powder containing iron in an amount of 20% by mass or more, having formed on a surface of the particles a coating layer of a silicon oxide, the silicon oxide coating layer having an average thickness of 1 nm or more and 30 nm or less, a coverage factor R defined by the following expression (1) of 70% or more, and a powder compact density of 4.0 g/cm³ or more:

R=Si×100/(Si+M) (1)

wherein Si represents a molar fraction of Si obtained by an X-ray photoelectron spectroscopy (XPS) measurement of the silicon oxide-coated soft magnetic powder, and M represents a total of molar fractions of metal elements and non-metal elements except for oxygen among elements constituting the soft magnetic powder obtained by the XPS measurement.

It is preferred that the silicon oxide-coated soft magnetic powder has a volume based cumulative 50% particle diameter D₅₀ obtained by a laser diffraction particle size distribution measurement method of 1.0 μm or more and 5.0 μm or less.

The present invention also provides a method for producing silicon oxide-coated soft magnetic powder containing soft magnetic powder containing iron in an amount of 20% by mass or more, having coated on a surface thereof a silicon oxide, the method including: a step of mixing water and an organic solvent to prepare a mixed solvent containing water in an amount of 1% by mass or more and 40% by mass or less; a dispersing step of adding soft magnetic powder containing iron in an amount of 20% by mass or more to the mixed solvent to provide a slurry having dispersed therein the soft magnetic powder; an alkoxide adding step of adding a silicon alkoxide to the slurry having dispersed therein the soft magnetic powder; a step of adding a hydrolysis catalyst for the silicon alkoxide to the slurry having dispersed therein the magnetic powder having the silicon alkoxide added thereto, so as to provide a slurry having dispersed therein soft magnetic powder coated with a silicon compound; a hydrolysis catalyst adding step of subjecting the slurry having dispersed therein soft magnetic powder coated with a silicon compound to solid-liquid separation, so as to provide soft magnetic powder coated with the silicon oxide; and a step of drying the soft magnetic powder coated with the silicon oxide.

In the method for producing silicon oxide-coated soft magnetic powder of the present invention, it is preferred that the silicon oxide coating layer of the silicon oxide-coated soft magnetic powder has an average thickness of 1 nm or more and 30 nm or less, a coverage factor R defined by the following expression (1) of 70% or more, and a powder compact density of 4.0 g/cm³ or more:

R=Si×100/(Si+M) (1)

wherein Si represents a molar fraction of Si obtained by an X-ray photoelectron spectroscopy (XPS) measurement of the silicon oxide-coated soft magnetic powder, and M represents a total of molar fractions of metal elements and non-metal elements except for oxygen among elements constituting the soft magnetic powder obtained by the XPS measurement.

In the method for producing silicon oxide-coated soft magnetic powder of the present invention, it is preferred that the silicon oxide-coated soft magnetic powder has a volume based cumulative 50% particle diameter D₅₀ obtained by a laser diffraction particle size distribution measurement method of 1.0 μm or more and 5.0 μm or less.

### Advantageous Effects of Invention

By applying the production method of the present invention, silicon oxide-coated soft magnetic powder that is excellent in insulating property and is capable of providing a high powder compact density can be produced.

### BRIEF DESCRIPTION OF DRAWINGS

FIG. 1 is an SEM micrograph of the silicon oxide-coated soft magnetic powder obtained in Example 2.

### DESCRIPTION OF EMBODIMENTS

### [Soft Magnetic Powder]

In the present invention, soft magnetic powder containing iron in an amount of 20% by mass or more is used as a starting material. Specific examples of the soft magnetic powder containing iron in an amount of 20% by mass or more include an Fe—Si alloy, an Fe—Si—Cr alloy, an Fe—Al—Si alloy (Sendust), and an Fe—Ni alloy (having an Ni mass of from 30 to 80% by mass) having a permalloy composition. Mo and Co may be added in a small amount (e.g., 10% by mass or less) depending on necessity. An alloy having Mo added thereto may have a crystal structure becoming amorphous, and therefore may be referred particularly to as amorphous powder.

In the description herein, the “soft magnetic powder containing iron in an amount of 20% by mass or more” may be referred simply to as “soft magnetic powder”. In the present invention, the magnetic characteristics of the soft magnetic powder are not particularly limited, and powder having a low coercive force (Hc) and a high saturation magnetization (σs) is preferred. The Mc is preferably as low as possible, and is preferably 3.98 kA/m (approximately 50 (Oe)) or less. The Mc that exceeds 3.98 kA/m is not suitable as a magnetic core since the energy loss in magnetic field reversal is increased.

The os is preferably as high as possible, and is preferably 100 Am²/kg (100 emu/g) or more. The saturation magnetization that is less than 100 Am²/kg not preferred since a large amount of the magnetic powder is required, and a magnetic core necessarily has an increased size.

In the present invention, while the average particle diameter of the primary particles of the soft magnetic powder is not particularly determined, powder having an average particle diameter of the primary particles of more than 0.80 pm and 5.0 pm or less, which is conventionally available one, has been available, and soft magnetic powder having an arbitrary average particle diameter of the primary particles within the range may be used depending on purposes.

### [Silicon Oxide Coating]

In the present invention, the surface of the particles constituting the soft magnetic powder is coated with an insulating silicon oxide by the wet coating method using a silicon alkoxide. The coating method using a silicon alkoxide is a method that is generally referred to as a sol-gel method, and is excellent in mass productivity than the dry method as described above.

The hydrolysis of a silicon alkoxide forms a silanol derivative through the substitution of all or a part of the alkoxy groups by hydroxy groups (OH groups). In the present invention, in which the surface of the soft magnetic powder is coated with the silanol derivative, the silanol derivative thus coated becomes to have a polysiloxane structure through condensation or polymerization under heating, and the polysiloxane structure further becomes silica (SiO₂) through heating. In the present invention, all the materials of from the silanol derivative coating having a part of the alkoxy groups remaining as an organic substance to the silica coating are generically referred to as a silicon oxide coating.

Examples of the silicon alkoxide used include trimethoxysilane, tetramethoxysilane, triethoxysilane, tetraethoxysilane, tripropoxysilane, tetrapropoxysilane, and tributoxysilane, and tetraethoxysilane is preferably used since a uniform coating layer may be formed due to the good wettability thereof to the soft magnetic particles.

The average thickness of the silicon oxide coating layer is preferably 1 nm or more and 30 nm or less, and more preferably 1 nm or more and 25 nm or less. In the case where the thickness is less than 1 nm, a large amount of defects exist in the coating layer, and it may be difficult to secure the insulating property. The thickness that exceeds 30 nm is not preferred since the powder compact density of the soft magnetic powder is decreased to deteriorate the magnetic characteristics although the insulating property may be enhanced. The average thickness of the silicon oxide coating layer may be measured by the dissolution method, and the details of the measurement method will be described later. In the case where the measurement by the dissolution method is difficult to perform, the average thickness can be obtained by the observation with a transmission electron microscope (TEM) or the observation with a scanning electron microscope (SEM) of the cross section of the silicon oxide coating layer. In this case, the average thickness can be obtained in such a manner that a TEM micrograph or a SEM micrograph of the cross section is taken, and the average value of 50 measurement points of an arbitrary particle is designated as the average thickness. The thickness obtained by this method is equivalent to that by the dissolution method.

The coverage factor R of the silicon oxide coating layer defined by the following expression (1) is preferably 70% or more:

R=Si×100/(Si+M) (1)

wherein Si represents the molar fraction of Si obtained by an X-ray photoelectron spectroscopy (XPS) measurement of the silicon oxide-coated soft magnetic powder, and M represents the total of the molar fractions of the metal elements and non-metal elements except for oxygen among the elements constituting the soft magnetic powder obtained by the XPS measurement. Examples of M measured by XPS include Fe, Ni, Cr, Co, Mo, and Al.

The coverage factor R has the following physical meaning.

XPS is a surface analysis method in which a solid surface is irradiated with a soft X-ray as an excitation source, and photoelectrons emitted from the solid surface are spectrally analyzed. In XPS, the incident X-ray penetrates to a certain depth (approximately from 1 to 10 pm) from the solid surface, but the escape depth of the excited photoelectrons is several nanometers, which is an extremely small value. This is because the excited photoelectrons have an intrinsic mean free path A depending on the kinetic energy thereof, which is a small value of from 0.1 nm to several nanometers. In the present invention, in the case where defects exists in the silicon oxide coating layer, photoelectrons derived from the constitutional component of the soft magnetic powder exposed on the defect portions are detected. Furthermore, even though no defect exists in the silicon oxide coating layer, photoelectrons derived from the constitutional component of the soft magnetic powder are detected in the case where there is a portion in which the average thickness of the silicon oxide coating layer is smaller than the escape depth of the photoelectrons derived from the constitutional component of the soft magnetic powder. Consequently, the coverage factor R can be a comprehensive index that represents the average thickness of the silicon oxide coating layer and the area ratio of the defect portions thereof.

For Fe—Ni powder used in the examples described later, R=Si×100/(Si+Fe+Ni) holds, and in the case where the thickness of the silicon oxide coating layer is larger than the escape depth of photoelectrons of Fe and Ni, and no defect exists in the silicon oxide coating layer, Fe+Ni=0 holds, resulting in a coverage factor R of 100%.

In the case where Si is contained as the constitutional component of the soft magnetic powder as in Fe—Si powder and Fe—Si—Cr powder, the coverage factor can be obtained by subtracting the molar fraction of Si constituting the soft magnetic powder from each of the molar fractions of Si of the denominator and the numerator of the expression (1).

The molar fraction of Si constituting the soft magnetic powder can be obtained in such a manner that the silicon oxide coating layer of the silicon oxide-coated soft magnetic powder is etched by an appropriate method and measured by XPS.

As the etching method, the silicon oxide film can be completely etched by etching the silicon oxide-coated soft magnetic powder to approximately 100 nm in terms of SiO₂ with an ion sputtering device attached to XPS, or by immersing the silicon oxide-coated soft magnetic powder in a 10% by mass sodium hydroxide aqueous solution under condition of 80° C. for 20 minutes.

### [Powder Compact Density]

In the present invention, the silicon oxide-coated soft magnetic powder preferably has a powder compact density of 4.0 g/cm³ or more, and more preferably 5.0 g/cm³ or more. The powder compact density influences the permeability of the powder compact magnetic core. With a low powder compact density, the permeability of the powder compact magnetic core becomes low, resulting in the increase of the size of the powder compact magnetic core required for providing the prescribed permeability, which is not preferred from the standpoint of the reduction in size of the powder compact magnetic core.

The powder compact density is preferably as high as possible, and the substantial upper limit of the powder compact density from the composition of the soft magnetic powder is approximately 7 g/cm³.

### [Volume Based Cumulative 50% Particle Diameter]

In the present invention, the volume based cumulative 50% particle diameter D₅₀ of the silicon oxide-coated soft magnetic powder obtained by a laser diffraction particle size distribution measurement method is preferably 1.0 um or more and 5.0 um or less. With a particle diameter of smaller than 1.0 μm, secondary aggregation frequently occurs in coating the silicon oxide, and the powder compact density cannot be 4.0 g/cm³ or more, resulting in the decrease of the permeability. The particle diameter that is 5.0 um or more is not preferred since the magnetic loss under high frequency may be increased in the use as an inductor.

### [Water Content]

The silicon oxide-coated soft magnetic powder of the present invention tends to adsorb water since the magnetic powder has a water absorbability due to the silanol groups existing on the surface thereof. The insulating property of the silicon oxide-coated soft magnetic powder tends to lower when water is adsorbed on the surface thereof, and therefore the water content of the silicon oxide-coated soft magnetic powder is preferably suppressed to a lower value. In the present invention, while the water content of the silicon oxide-coated soft magnetic powder is not particularly determined, the water content with respect to the total silicon oxide-coated soft magnetic powder is preferably 0.25% by mass or less. The water content can be 0.25% by mass or less by drying the silicon oxide-coated soft magnetic powder at 80° C. or more in the drying step described later. The water content is more preferably 0.15% by mass or less. It is difficult to make the water content to 0 since the adsorption of water in the air occurs, and the magnetic powder having a water content of 0.01% by mass or more is generally obtained.

### [Mixed Solvent and Dispersing Step]

In the production method of the present invention, in the state where soft magnetic powder is dispersed in a mixed solvent of water and an organic solvent by agitating with a known mechanical means, the surface of the soft magnetic powder is coated with a silicon oxide by a sol-gel method, and before the coating operation, a dispersing step of retaining a slurry containing the soft magnetic powder in the mixed solvent is provided. The soft magnetic powder has on the surface thereof an extremely thin oxide of Fe, which is the major component of the soft magnetic powder, and in the dispersing step, the Fe oxide is hydrated with water contained in the mixed solvent. The hydrated Fe oxide surface is a kind of a solid acid, which exhibits a behavior similar to a weak acid as a Bronsted acid, and therefore, in the addition of a silicon alkoxide in the next step to the slurry containing the soft magnetic powder in the mixed solvent, the reactivity between the silanol derivative as a hydrolyzate of the silicon alkoxide and the surface of the soft magnetic powder is enhanced.

The content of water in the mixed solvent is preferably 1% by mass or more and 40% by mass or less, more preferably 5% by mass or more and 30% by mass or less, and further preferably 10% by mass or more and 20% by mass or less. In the case where the content of water is less than 1% by mass, the function of hydrating the Fe oxide described above may be insufficient, and in the case where the content of water exceeds 40% by mass, the hydrolysis rate of the silicon alkoxide is increased to fail to provide a uniform silicon oxide coating layer, both cases of which are not preferred.

The organic solvent used in the mixed solvent is preferably an aliphatic alcohol having affinity with water, such as methanol, ethanol, 1-propanol, 2-propanol, butanol, pentanol, and hexanol. However, an organic solvent that has a solubility parameter that is too close to that of water may decrease the reactivity of water in the mixed solvent, and therefore it is more preferred to use 1-propanol, 2-propanol (isopropyl alcohol), butanol, pentanol, or hexanol.

In the present invention, the temperature in the dispersing step is not particularly determined, and is preferably 20° C. or more and 70° C. or less. The reaction temperature that is less than 20° C. is not preferred since the rate of the hydration reaction of the Fe oxide may be lowered. The reaction temperature that exceeds 70° C. is not preferred since the hydrolysis reaction rate of the silicon alkoxide in the alkoxide adding step as the next step may be increased to deteriorate the uniformity of the silicon oxide coating layer. In the present invention, the retaining time in the dispersing step is also not particularly determined, and the condition may be appropriately selected to make the retention time of 1 minute or more and 30 minutes or less for performing the hydration reaction of the Fe oxide uniformly.

### [Alkoxide Adding Step]

To the slurry having the soft magnetic powder dispersed in the mixed solvent obtained in the dispersing step under agitation with a known mechanical means, a silicon alkoxide is added, and then the slurry is retained to that state for a prescribed period of time. The silicon alkoxide used may be trimethoxysilane, tetramethoxysilane, triethoxysilane, tetraethoxysilane, tripropoxysilane, tetrapropoxysilane, tributoxysilane, and the like, as described above.

The silicon alkoxide added in this step becomes a silanol derivative through hydrolysis by the action of water contained in the mixed solvent. The formed silanol derivative forms a reaction layer of the silanol derivative on the surface of the soft magnetic powder through condensation, chemical adsorption, and the like. It is considered that the hydrolysis of the silicon alkoxide proceeds gradually since no hydrolysis catalyst is added in this step, and thus the reaction layer of the silanol derivative is formed uniformly.

The substantially whole amount of the silicon alkoxide added in this step is used for the formation of the silicon oxide coating layer, and therefore the amount thereof added may be such an amount that makes an average thickness of the silicon oxide coating layer of 1 nm or more and 30 nm or less. The amount of the silicon alkoxide added may be determined specifically by the following manner.

Assuming that the mass of the soft magnetic powder contained in the slurry is Gp (g), the BET specific surface area of the soft magnetic powder before coating is S (m²/g), and the target thickness of the silicon oxide coating layer is t (nm), the total volume of the silicon oxide coating layer is V=Gp×S×t (10⁻⁵ m³), and assuming that the density of the silicon oxide coating layer is d=2.65 (g/cm³=10⁶ g/m³), the mass of the silicon oxide coating layer is Gc=0.1V×d (g). Accordingly, the molar number of Si contained in the silicon oxide coating layer can be obtained by dividing Gc by the molecular weight of SiO₂, i.e., 60.08. In the production method of the present invention, the silicon alkoxide is added to the slurry having the soft magnetic powder dispersed in the mixed solvent, in such an amount that corresponds to the target thickness t (nm).

It has been confirmed that the average thickness of the silicon oxide coating layer that is measured by cutting the silicon oxide-coated soft magnetic powder with a focused ion beam (FIB) processing device and observing with a transmission electron microscope (TEM) agrees accurately with the thickness that is obtained by the dissolution method described later with the assumption that the density of the silicon oxide coating layer is d=2.65 (g/cm³).

In the present invention, the reaction temperature in the alkoxide adding step is not particularly determined, and is preferably 20° C. or more and 70° C. or less. The reaction temperature that is less than 20° C. is not preferred since the reaction rate of the surface of the soft magnetic powder and the silanol derivative may be lowered. The reaction temperature that exceeds 70° C. is not preferred since the hydrolysis reaction rate of the silicon alkoxide added is increased to deteriorate the uniformity of the silicon oxide coating layer. In the present invention, the reaction time of the alkoxide adding step is not particularly determined, and the condition may be appropriately selected to make the reaction time of 10 minutes or less for performing the reaction of the surface of the soft magnetic powder and the silanol derivative uniformly.

### [Hydrolysis Catalyst Adding Step]

In the production method of the present invention, after forming the reaction layer of the silanol derivative on the surface of the soft magnetic powder in the alkoxide adding step, a hydrolysis catalyst for the silicon alkoxide is added to the slurry having the soft magnetic powder dispersed in the mixed solvent under agitation with a known mechanical means. In this step, the addition of the hydrolysis catalyst accelerates the hydrolysis reaction of the silicon alkoxide, and the film forming rate of the silicon oxide coating layer is increased. In this and later steps, the similar procedures as the ordinary film forming method by the sol-gel method may be performed.

The hydrolysis catalyst used may be an alkali catalyst. The use of an acid catalyst is not preferred since Fe as the major component of the soft magnetic powder may be dissolved. The alkali catalyst used is preferably aqueous ammonia since aqueous ammonia unlikely leaves impurities in the silicon oxide coating layer, and is easily available.

In the present invention, the reaction temperature in the hydrolysis catalyst adding step is not particularly determined, and may be the same as the reaction temperature in the alkoxide adding step as the preceding step. In the present invention, the reaction time in the hydrolysis catalyst adding step is also not particularly determined, and the condition may be appropriately selected to make the reaction time of 5 minutes or more and 120 minutes or less since the prolonged reaction time is economically disadvantageous.

### [Solid-Liquid Separation and Drying]

The silicon oxide-coated soft magnetic powder is recovered from the slurry containing the silicon oxide-coated soft magnetic powder obtained through the aforementioned sequence of steps, by a known solid-liquid separation means. The solid-liquid separation means used may be a known solid-liquid separation means, such as filtration, centrifugal separation, and decantation. In the solid-liquid separation, an aggregating agent may be added for performing the solid-liquid separation.

The silicon oxide-coated soft magnetic powder thus recovered is dried in the air atmosphere at a temperature of 80° C. or more. By drying at 80° C. or more, the water content of the silicon oxide-coated soft magnetic powder can be decreased to 0.25% by mass or less. The drying temperature is preferably 85° C. or more, and more preferably 90° C. or more. The drying temperature is preferably 400° C. or less, and more preferably 150° C. or less, for preventing the silicon oxide coating from being peeled off. In the case where the oxidation of the soft magnetic powder is to be prevented, the drying may be performed in an inert gas atmosphere or a vacuum atmosphere.

### [Measurement of Si Content]

The Si content was measured by the weight measurement method. Hydrochloric acid and perchloric acid were added to the specimen, which was thermally decomposed, and heated until white smoke of perchloric acid is generated. Subsequently, the heating was continued to dryness. After spontaneously cooling, water and hydrochloric acid were added thereto, and the soluble salts were dissolved under heating. The insoluble residue was filtered with filter paper, and the residue was placed in a crucible, and dried to ash. After spontaneously cooling, the residue was weighed along with the crucible. Small amounts of sulfuric acid and hydrofluoric acid were added thereto, and the mixture was heated to dryness, and then ignited. The residue was weighed along with the crucible. The weight difference was obtained by subtracting the second weighed value from the first weighed value, and the Si concentration was obtained from the weight difference in terms of SiO₂.

### [Calculation of Average Thickness of Silicon Oxide Coating Layer]

Assuming that the Si content of the silicon oxide-coated soft magnetic powder measured by the aforementioned method is A (% by mass), the mass ratio B (% by mass) of the silicon oxide coating layer can be calculated from the atomic weight of Si and the molecular weight of SiO₂ according to the following expression. The numeral 10 in the following expression is the conversion factor.

B=A×(molecular weight of SiO₂)/(atomic weight of Si)=A×60.08/28.09

The average thickness t (nm) of the silicon oxide coating layer can be shown by the following expression using S (m²/g) and d (g/cm³) described above.

t (nm)=10×B/(d×S)

The average thickness of the silicon oxide coating layer calculated assuming that the value of d is 2.56 g/cm³ agrees accurately with the TEM observation result, as described above.

### [Measurement of BET Specific Surface Area]

The BET specific surface area was obtained by the BET one-point method with 4 Sorb US, produced by Yuasa Ionics Co., Ltd.

### [SEM Observation]

The SEM observation was performed at an acceleration voltage of 3 kV and a magnification of 30,000 with S-4700, produced by Hitachi High-Technologies Corporation.

### [XPS Measurement]

The XPS measurement was performed with PHI 5800 ESCA SYSTEM, produced by Ulvac-Phi, Inc. The analysis area was 800 pm in diameter, the X-ray source was an Al tube, the power of the X-ray source was 150 W, and the analysis angle was 45°. The molar fractions of Si, Fe, and Ni were calculated with the built-in computer of the apparatus by using the photoelectron spectra thereof, i.e., the spectrum of the 2p3/2 orbital for Si, the spectrum of the 2p3/2 orbital for Fe, and the spectrum of the 2p3/2 orbital for Ni, and the relative sensitivity coefficients of the respective photoelectron spectra. In the case where Co and Cr were analyzed, the 2p orbital was used as the spectrum species. The background removing process was performed by the Shirley method. The sputter etching was not performed, and the photoelectron spectrum was measured for the outermost surface of the particle.

The resulting values were substituted into the corresponding element symbols in the expression (1), and the coverage factor R (%) was calculated.

### [Measurement of Volume Resistivity and Powder Compact Density]

The volume resistivity of the silicon oxide-coated soft magnetic powder was measured in such a manner that 1.0 g of the powder was vertically pressed at 13 to 64 MPa (4 to 20 kN), to which a voltage was applied, and measured by the double ring electrode method with a powder resistance measurement unit (MCP-PD51), produced by Mitsubishi Chemical Analytech Co., Ltd., a high resistance resistivity meter Hiresta UP (MCP-HT450), produced by Mitsubishi Chemical Analytech Co., Ltd., and a high resistance powder measurement system software, produced by Mitsubishi Chemical Analytech Co., Ltd.

The powder compact density was calculated from the thickness of the specimen pressed at 64 MPa (20 kN) and the weight thereof.

The volume resistivity at 64 MPa (20 kN) is preferably 1.0×10⁶ Ω·cm or more, and more preferably 1.0×10⁷ Ω·cm or more.

### [Laser Diffraction Particle Size Distribution Measurement]

The particle size distributions of the soft magnetic powder before and after coating the silicon oxide coating were measured with a laser diffraction particle size distribution measuring apparatus (HELOS Particle Size Distribution Measuring Apparatus (HELOS & RODOS), produced by Sympatec GmbH). The volume based cumulative 10% particle diameter (D₁₀), the volume based cumulative 50% particle diameter (D₅₀), and the volume based cumulative 90% particle diameter (D₉₀) were obtained by the apparatus, and the cumulative 50% particle diameter (D₅₀) was designated as the average particle diameter.

### [Measurement of Permeability (μ′)]

The soft magnetic powder before or after coating the silicon oxide coating and a bisphenol F type epoxy resin (one-component epoxy resin B-1106, produced by Tesk Co., Ltd.) were weighed at a mass ratio of 90/10, and kneaded with a rotation and revolution mixer (ARE-250, produced by Thinky Corporation), so as to provide a paste having the test powder dispersed in the epoxy resin. The paste was dried on a hot plate at 60° C. for 2 hours to provide a composite of the metal powder and the resin, and the composite was then pulverized into particles, which were designated as composite powder. 0.2 g of the composite powder was placed in a toroidal vessel and applied with a load of 9,800 N (1 ton) with a hand press to provide a molded article having a toroidal shape having an outer diameter of 7 mm and an inner diameter of 3 mm. The molded article was measured for the real part μ′ of the complex relative permeability at 100 MHz with an RF impedance analyzer (E4990A, produced by Keysight Technologies, Inc.), a terminal adapter (42942A, produced by Keysight Technologies, Inc.), and a test fixture (16454A, produced by Keysight Technologies, Inc.).

The use of the silicon oxide-coated soft magnetic powder of the present invention can provide a molded article having a real part μ′ of the magnetic permeability at 100 MHz of 4.5 or more, and therefore the molded article produced by using the silicon oxide-coated soft magnetic powder of the present invention exhibits excellent permeability characteristics, and can be favorably used for the purpose of a magnetic core of an inductor, and the like, which is demanded to have a reduced size.

### [Measurement of Water Content]

The water content of the silicon oxide-coated soft magnetic powder was measured by the coulometric titration method with a water evaporator, EV-2010, produced by Hiranuma Sangyo Co., Ltd. Specifically, a measurement specimen was placed in a measurement cell of the water evaporator, EV-2010, heated to 300° C., and then measured, and the measured value was designated as the water content of the silicon oxide-coated soft magnetic powder.

### EXAMPLES

### Example 1

In a 1,000 mL reaction vessel, 70 g of pure water and 400 g of isopropyl alcohol (IPA) were placed under room temperature, and mixed with agitation blades to form a mixed solvent, and then 250 g of Fe—Ni alloy powder (Fe: 50% by mass, Ni 50% by mass, BET specific surface area: 0.77 m²/g, average particle diameter: 1.9 μm, powder compact density: 5.47 g/cm³) as soft magnetic powder was added to the mixed solvent to provide a slurry having the soft magnetic powder dispersed therein. Thereafter, the slurry was heated from room temperature to 40° C. while agitating at an agitation speed of 600 rpm. During the period, the retention time of the slurry in the dispersing step was 15 minutes.

To the slurry having the soft magnetic powder dispersed in the mixed solvent under agitation, 3.74 g of tetraethoxysilane (TEOS, produced by Wako Pure Chemical Industries, Ltd.) collected to a small volume beaker was added at one time. TEOS attached to the wall of the small volume beaker was washed away with 5 g of IPA and added to the reaction vessel. After adding TEOS, the mixture was continuously agitated for 5 minutes to perform the reaction between the hydrolysate of TEOS and the surface of the soft magnetic powder.

Subsequently, to the slurry retained for 5 minutes after adding TEOS, 45 g of 28% by mass aqueous ammonia was added at an addition rate of 1 g/min. After completing the addition of aqueous ammonia, the slurry was retained for 1 hour under agitation, so as to form a silicon oxide coating layer on the surface of the soft magnetic powder.

Thereafter, the slurry was filtered with a press filtering device, and vacuum dried at 120° C. for 3 hours to provide silicon oxide-coated soft magnetic powder.

The resulting silicon oxide-coated soft magnetic powder was subjected to the compositional analysis, the XPS measurement, and the measurement of the water content, and the thickness t (nm) of the silicon oxide coating layer, the coverage factor R (%), and the water content were calculated. The thickness t was 2 nm, the coverage factor R was 81% (Fe and Ni constituting the soft magnetic powder were detected as M by the XPS measurement), and the water content was 0.10% by mass. The results are shown an. Table 1. Table 1 also shows the measurement result of the particle size distribution of the silicon oxide-coated soft magnetic powder and the measurement results of the powder compact density and the volume resistivity of the powder compact.

### Examples 2 to 5

Silicon oxide-coated soft magnetic powder was obtained in the same procedures as in Example 1 except that the amount of TEAS added to the slurry was changed to 9.36 g for Example 2, 21.0 g for Example 3, 31.4 g for Example 4, and 41.9 g for Example 5. The thickness of the silicon oxide coating layer, the coverage factor, and the water content calculated for the resulting silicon oxide-coated soft magnetic powder, and the measurement results of the particle size distribution of the silicon oxide-coated soft magnetic powder, the powder compact density, and the volume resistivity of the powder compact are shown in Table 1. In Examples 2 to 4, Fe and Ni constituting the soft magnetic powder were detected as M by the XPS measurement, and in Example 5, a metal element and a non-metal element except for oxygen were not measured.

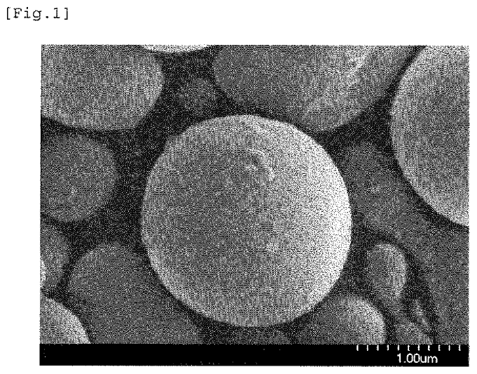

FIG. 1 shows the SEM observation result of the silicon oxide-coated soft magnetic powder obtained in Example 2. In FIG. 1, the length shown by the 11 white vertical lines shown in the right lower part is 1.0 pm.

When the amount of TEAS added was increased, the thickness of the silicon oxide coating layer was increased, and the coverage factor was also increased. With the increase of the thickness, the volume resistivity of the powder compact was increased, but the powder compact density was decreased. The volume resistivity of the powder compact obtained in the example of the present invention was one-order magnitude larger than the comparative examples described later.

The average particle diameter was slightly increased by increasing the thickness of the silicon oxide due to the aggregation of the soft magnetic particles with the silicon oxide functioning as a binder, but the increased value was up to 3.5 pm even with a thickness of 20 nm, which indicated that the increase of the particle diameter due to the secondary aggregation was small.

### Example 6

Silicon oxide-coated soft magnetic powder was obtained in the same procedures as in Example 1 except that iron powder (purity: 99% by mass or more, average particle diameter: 5.5 pm, specific surface area: 0.40 m²/g) was used as the soft magnetic powder, and the amount of TEOS added to the slurry was 4.80 g (corresponding to a thickness of SiO₂ of 5 nm). The thickness of the silicon oxide coating layer, the coverage factor, and the water content calculated for the resulting silicon oxide-coated soft magnetic powder, and the measurement results of the particle size distribution of the silicon oxide-coated soft magnetic powder, the powder compact density, and the volume resistivity of the powder compact are shown in Table 1. In the case where the iron powder was used as soft magnetic powder, in which Fe constituting the soft magnetic powder was detected as M b_{y} the XPS measurement, the good volume resistivity of the powder compact and the good permeability were obtained.

### Example 7

Silicon oxide-coated soft magnetic powder was obtained in the same procedures as in Example 2 except that the drying temperature was 80° C. The thickness of the silicon oxide coating layer, the coverage factor, and the water content calculated for the resulting silicon oxide-coated soft magnetic powder, and the measurement results of the particle size distribution of the silicon oxide-coated soft magnetic powder, the powder compact density, and the volume resistivity of the powder compact are shown in Table 1. In the case where Fe and Ni constituting the soft magnetic powder were detected as M by the XPS measurement, and the drying temperature was 80° C., the water content was slightly increased, and the volume resistivity of the powder compact was slightly decreased.

### Comparative Example 1

The soft magnetic Fe—Ni alloy powder used in Examples 1 to 5 was not coated with a silicon oxide coating, and measured for the specific surface area by the BET method, the particle size distribution by the laser diffraction method, and the volume resistivity and the powder compact density of the powder. The measurement results are shown in Table 1. The BET specific surface area of the Fe—Ni alloy powder in this comparative example was 0.77 m²/g as described above. Fe and Ni constituting the soft magnetic powder were detected as M by the XPS measurement.

It was understood from the measurement results in this comparative example that the volume resistivity of the powder compact was six-order magnitude increased even with the silicon oxide coating layer having a small thickness as in Example 1.

### Comparative Example 2

The aforementioned Fe—Ni alloy powder was coated with silicon oxide coating according to the method described in Example 1 of PTL 2. In this production method, the dispersing step and the alkoxide adding step defined in the scope of claim of the present invention were not performed, but the soft magnetic powder was reacted immediately with the coating liquid having a hydrolysis catalyst added thereto. Specifically, 500 g of the Fe—Ni alloy powder was immersed in a hydrolysis solution at room temperature of 25° C. containing 100 mL of a mixed solvent of 14 g of tetraethoxysilane (produced by Kanto Chemical Co., Inc.) and IPA, 2 mL of concentrated aqueous ammonia (28% by mass), and 30 g of water, and agitated with a propeller agitator for 3 hours. Thereafter, the silicon oxide-coated soft magnetic powder and the hydrolysis solution were separated, and the silicon oxide-coated soft magnetic powder was treated at 120° C. for 1 hour to remove the IPA solution and water. Thereafter, the resulting silicon oxide-coated soft magnetic powder was subjected to the same evaluation as in the examples of the present invention. The evaluation results are shown in Table 1. Fe and Ni constituting the soft magnetic powder were detected as M by the XPS measurement.

In the silicon oxide-coated soft magnetic powder obtained in this comparative example, the thickness of the silicon oxide coated soft magnetic layer was 4 nm, which was in the scope of claim of the present invention, but the coverage factor thereof was 52%, and the volume resistivity of the powder compact was inferior to those of the examples of the present invention.

### Comparative Example 3

Silicon oxide-coated soft magnetic powder was obtained under the same conditions as in Example 1 except that water was not used as the solvent for forming the slurry of the soft magnetic powder, but only 400 g of IPA was used. The characteristics of the resulting silicon oxide-coated soft magnetic powder are shown in Table 1. Fe and Ni constituting the soft magnetic powder were detected as M by the XPS measurement. In the silicon oxide-coated soft magnetic powder obtained in this comparative example, the thickness of the silicon oxide coated soft magnetic layer was 2 nm, which was the same as in Example 1, but the coverage factor thereof was 58%, and the volume resistivity of the powder compact was inferior to those of the examples of the present invention.

### Comparative Example 4

Silicon oxide-coated soft magnetic powder was obtained under the same conditions as in comparative Example 3 except that the amount of TEOS added to the slurry was 55.4 g (corresponding to a thickness of SiO₂ of 30 nm). The thickness of the silicon oxide coating layer, the coverage factor, and the water content calculated for the resulting silicon oxide-coated soft magnetic powder, and the measurement results of the particle size distribution of the silicon oxide-coated soft magnetic powder, the powder compact density, and the volume resistivity of the powder compact are shown in Table 1. Fe and Ni constituting the soft magnetic powder were detected as M by the XPS measurement.

In this comparative example, the coverage factor was as low as 69%, and the volume resistivity of the powder compact was low, even though the large thickness of SiO₂ was as large as 30 nm.

### Comparative Example 5

The iron powder used in Example 6 without the silicon oxide coating was measured for the water content, the powder compact density, and the volume resistivity of the powder compact, which are shown in Table 1. Fe constituting the soft magnetic powder was detected as M by the XPS measurement.

It is understood from Examples and Comparative Examples that with the dispersing step and the alkoxide adding step defined in the present invention, a silicon oxide coating layer that has a high coverage factor even with a small thickness can be obtained, and as a result, silicon oxide-coated soft magnetic powder having a high volume resistivity of a powder compact can be obtained.

TABLE 1

| | Si | | Cover- | Particle size | Powder compact resistance | | | | | Powder | | |
|---|---|---|---|---|---|---|---|---|---|---|---|---|
| | content | Thick- | age | measurement | (Ω · cm) | | | | | compact | Water | Permeability |
| | (% by | ness | factor | D₅₀ | Pressing force (kN) | | | | | density | content | (at 100 MHz) |
| | mass) | (nm) | (%) | (μm) | 4 | 8 | 12 | 16 | 20 | (g/cm³) | (%) | μ′ |
| Example 1 | 0.20 | 2 | 81 | 1.9 | 1.0 × 10⁹ | 2.5 × 10⁸ | 7.8 × 10⁷ | 2.7 × 10⁷ | 1.1 × 10⁷ | 5.45 | 0.10 | 7.4 |
| Example 2 | 0.50 | 5 | 96 | 2.1 | 3.7 × 10⁹ | 2.7 × 10⁹ | 2.3 × 10⁹ | 2.0 × 10⁹ | 1.8 × 10⁹ | 5.16 | 0.11 | 6.5 |
| Example 3 | 1.0 | 10 | 97 | 2.5 | 4.7 × 10⁹ | 3.3 × 10⁹ | 2.8 × 10⁹ | 2.4 × 10⁹ | 2.1 × 10⁹ | 5.06 | 0.11 | 6.3 |
| Example 4 | 1.4 | 15 | 98 | 2.7 | 6.4 × 10⁹ | 4.5 × 10⁹ | 4.6 × 10⁹ | 3.7 × 10⁹ | 2.4 × 10⁹ | 4.62 | 0.12 | 5.5 |
| Example 5 | 1.9 | 20 | 100 | 3.5 | 9.4 × 10⁹ | 6.6 × 10⁹ | 5.3 × 10⁹ | 4.5 × 10⁹ | 3.9 × 10⁹ | 4.22 | 0.13 | 5.0 |
| Example 6 | 0.25 | 5 | 97 | 5.5 | 4.3 × 10¹⁰ | 2.6 × 10¹⁰ | 2.0 × 10¹⁰ | 1.6 × 10¹⁰ | 1.3 × 10¹⁰ | 5.82 | 0.08 | 6.8 |
| Example 7 | 0.50 | 5 | 96 | 2.1 | 1.6 × 10⁹ | 2.3 × 10⁸ | 4.6 × 10⁷ | 1.6 × 10⁷ | 4.9 × 10⁶ | 5.17 | 0.22 | 6.5 |
| Comparative | 0 | 0 | 0 | 1.9 | 6.1 × 10³ | 3.0 × 10² | 5.3 × 10¹ | 2.0 × 10¹ | 1.0 × 10¹ | 5.80 | 0.03 | 7.9 |
| Example 1 | | | | | | | | | | | | |
| Comparative | 0.38 | 4 | 52 | 1.9 | 2.5 × 10⁸ | 2.8 × 10⁷ | 4.8 × 10⁶ | 1.6 × 10⁶ | 6.7 × 10⁵ | 5.10 | 0.10 | 6.3 |
| Example 2 | | | | | | | | | | | | |
| Comparative | 0.21 | 2 | 58 | 1.9 | 6.3 × 10⁷ | 3.6 × 10⁶ | 5.2 × 10⁵ | 1.9 × 10⁵ | 5.4 × 10⁴ | 5.31 | 0.11 | 6.8 |
| Example 3 | | | | | | | | | | | | |
| Comparative | 2.90 | 30 | 69 | 3.8 | 6.9 × 10⁸ | 5.2 × 10⁷ | 5.7 × 10⁶ | 2.3 × 10⁶ | 8.3 × 10⁵ | 3.66 | 0.11 | 4.1 |
| Example 4 | | | | | | | | | | | | |
| Comparative | 0 | 0 | 0 | 5.4 | 5.7 × 10⁻¹ | 2.2 × 10⁻¹ | 1.4 × 10⁻¹ | 1.0 × 10⁻¹ | 8.1 × 10⁻² | 5.82 | 0.02 | 6.8 |
| Example 5 | | | | | | | | | | | | |

1. Silicon oxide-coated soft magnetic powder comprising soft magnetic powder containing iron in an amount of 20% by mass or more, having coated on a surface thereof a silicon oxide, the silicon oxide coating layer having an average thickness of 1 nm or more and 30 nm or less, a coverage factor R defined by the following expression (1) of 70% or more, and a powder compact density of 4.0 g/cm³ or more:
R=Si×100/(Si+M) (1)
wherein Si represents a molar fraction of Si obtained by an X-ray photoelectron spectroscopy (XPS) measurement of the silicon oxide-coated soft magnetic powder, and M represents a total of molar fractions of metal elements and non-metal elements except for oxygen among elements constituting the soft magnetic powder obtained by the XPS measurement.

2. The silicon oxide-coated soft magnetic powder according to claim 1, wherein the silicon oxide-coated soft magnetic powder has a volume based cumulative 50% particle diameter D₅₀ obtained by a laser diffraction particle size distribution measurement method of 1.0 μm or more and 5.0 μm or less.

3. A method for producing silicon oxide-coated soft magnetic powder containing soft magnetic powder containing iron in an amount of 20% by mass or more, having coated on a surface thereof a silicon oxide, the method comprising:
a step of mixing water and an organic solvent to prepare a mixed solvent containing water in an amount of 1% by mass or more and 40% by mass or less;
a dispersing step of adding soft magnetic powder containing iron in an amount of 20% by mass or more to the mixed solvent to provide a slurry having dispersed therein the soft magnetic powder;
an alkoxide adding step of adding a silicon alkoxide to the slurry having dispersed therein the soft magnetic powder;
a hydrolysis catalyst adding step of adding a hydrolysis catalyst for the silicon alkoxide to the slurry having dispersed therein the magnetic powder having the silicon alkoxide added thereto, so as to provide a slurry having dispersed therein soft magnetic powder coated with a silicon compound;
a step of subjecting the slurry having dispersed therein soft magnetic powder coated with a silicon compound to solid-liquid separation, so as to provide soft magnetic powder coated with the silicon oxide; and
a step of drying the soft magnetic powder coated with the silicon oxide.

4. The method for producing silicon oxide-coated soft magnetic powder according to claim 3, wherein the silicon oxide coating layer of the silicon oxide-coated soft magnetic powder has an average thickness of 1 nm or more and 30 nm or less, a coverage factor R defined by the following expression (1) of 70% or more, and a powder compact density of 4.0 g/cm³ or more:
R=Si×100/(Si+M) (1)
wherein Si represents a molar fraction of Si obtained by an X-ray photoelectron spectroscopy (XPS) measurement of the silicon oxide-coated soft magnetic powder, and M represents a total of molar fractions of metal elements and non-metal elements except for oxygen among elements constituting the soft magnetic powder obtained by the XPS measurement.

5. The method for producing silicon oxide-coated soft magnetic powder according to claim 3, wherein the silicon oxide-coated soft magnetic powder has a volume based cumulative 50% particle diameter D₅₀ obtained by a laser diffraction particle size distribution measurement method of 1.0 μm or more and 5.0 μm or less.
